(19) United States
(12) Patent Application Publication
(10) Pub. No.: US 2024/0233111 A1
(43) Pub. Date: Jul. 11, 2024

(54) INSPECTION DEVICE AND METHOD OF INSPECTION USING THE SAME

(71) Applicant: Samsung Display Co., Ltd., Yongin-Si (KR)

(72) Inventors: DOOHYOUNG LEE, Yongin-si (KR); KUHWAN CHUNG, Yongin-si (KR); JOO DONG YUN, Yongin-si (KR); DONGHA LEE, Yongin-si (KR); JUWON LEE, Yongin-si (KR); SANGHYUNG LIM, Yongin-si (KR)

(21) Appl. No.: 18/537,975

(22) Filed: Dec. 13, 2023

(30) Foreign Application Priority Data
Jan. 10, 2023 (KR) 10-2023-0003363
Nov. 30, 2023 (KR) 10-2023-0171114

(51) Int. Cl. G06T 7/00; G06T 7/62

(52) U.S. Cl. CPC G06T 7/0008; G06T 7/001; G06T 7/62; G06T 2207/20084; G06T 2207/30148

(57) ABSTRACT

Provided is an inspection device including an image output unit configured to output an inspection image for an inspection target including an oxide semiconductor, a storage unit configured to store a plurality of reference images and a plurality of reference data indicating oxygen vacancy distribution, which are generated through an artificial neural network, and a neural network processing unit configured to compare the reference images with the inspection image and select a selection reference image corresponding to the inspection image, and output an oxygen vacancy distribution image based on selection reference data corresponding to the selection reference image.

### CROSS-REFERENCE TO RELATED APPLICATIONS

This U.S. non-provisional patent application claims priority under 35 U.S.C. § 119 to Korean Patent Application No. 10-2023-0003363, filed on Jan. 10, 2023, and Korean Patent Application No. 10-2023-0171114, filed on Nov. 30, 2023, the entire contents of which are hereby incorporated by reference.

### BACKGROUND

The present disclosure herein relates to an inspection device having improved reliability and a method of inspection using the same.

A thin film transistor constituting a display device may include a semiconductor layer, a gate electrode, a source electrode, and a drain electrode. Recently, an oxide semiconductor including indium (In), gallium (Ga), zinc (Zn), tin (Sn), and the like is used as a semiconductor layer, and the oxide semiconductor has excellent semiconductor properties such as high carrier mobility and low leakage current. In addition, the oxide semiconductor allows film formation at a low temperature, and has a large optical band gap and thus allows film formation on a plastic substrate and a film substrate, and, accordingly, the oxide semiconductor is applied to a display device in part.

The oxide semiconductor is not sufficiently heat resistant, and may thus cause defects due to oxygen which is released by heat treatment or plasma treatment in a process of manufacturing a thin film transistor. The defects formed in the oxide semiconductor may alter the carrier mobility of the oxide semiconductor, and, accordingly, may affect characteristics of the thin film transistor.

Therefore, it is critical to evaluate defects of an oxide semiconductor film-formed in a process of manufacturing a display device, and thus various studies on a method for analyzing defects are underway.

### SUMMARY

The present disclosure provides an inspection device inspecting oxygen vacancy distribution of an inspection target including an oxide semiconductor, and a method of inspection using the same.

An embodiment of the inventive concept provides an inspection device including an image output unit configured to output an inspection image for an inspection target including an oxide semiconductor, a storage unit configured to store a plurality of reference images and a plurality of reference data indicating oxygen vacancy distribution, which are generated through an artificial neural network, and a neural network processing unit configured to compare the inspection image with the reference images and select a selection reference image corresponding to the inspection image, and output an oxygen vacancy distribution image based on selection reference data corresponding to the selection reference image.

In an embodiment, the reference images and the reference data may be generated by learning comparison images for a plurality of comparison targets comprising an oxide semiconductor, and comparison data indicating oxygen vacancy distributions of the comparison targets through the artificial neural network.

In an embodiment, the comparison image may be generated from a first region of the comparison target, and the comparison data may be generated from a second region of the comparison target.

In an embodiment, the second region may be larger than the first region.

In an embodiment, the first region may be a portion of the second region.

In an embodiment, the first region may correspond to a portion of the oxide semiconductor.

In an embodiment, an area of the first region may be about 900 nm² to about 1600 nm².

In an embodiment, the comparison target may include a plurality of comparison targets and oxide semiconductors included in the plurality of comparison targets may be different in concentration of oxygen vacancy.

In an embodiment, the comparison data may be generated using X-ray photoelectron spectroscopy (XPS).

In an embodiment, each of the inspection image and the comparison image may be generated using an energy dispersive spectroscopy (EDS).

In an embodiment, the artificial neural network may be a convolutional neural network.

In an embodiment, the plurality of reference images may be acquired using samples each having a predetermined oxygen vacancy concentration.

In an embodiment, the inspection device may further include a detection unit configured to detect whether the inspection target is defective based on the oxygen vacancy distribution image.

In an embodiment of the inventive concept, a method of inspection includes generating a plurality of reference images and a plurality of reference data indicating oxygen vacancy distribution through an artificial neural network, outputting an inspection image for an inspection target including an oxide semiconductor, selecting a selection reference image corresponding to the inspection image by comparing the inspection image with the reference images, and outputting an oxygen vacancy distribution image base on selection reference data corresponding to the selection reference image.

In an embodiment, the generating of the reference images and the reference data may include learning comparison image of comparison target including oxide semiconductors, and comparison data indicating an oxygen vacancy distributions of the comparison target through the artificial neural network.

In an embodiment, the comparison image may be generated from a first region of the comparison target, and the comparison data may be generated from a second region of the comparison target.

In an embodiment, the comparison data may be generated using X-ray photoelectron spectroscopy (XPS).

In an embodiment, the comparison data may be generated by a light source disposed to emit light having a predetermined angle with respect to a surface of the comparison target.

In an embodiment, the comparison image may be generated using energy dispersive spectroscopy (EDS).

In an embodiment, the method of inspection may further include detecting whether the inspection target is defective based on the oxygen vacancy distribution image.

In an embodiment of the inventive concept, an inspection device includes an image output unit configured to output an inspection image for an inspection target including a plurality of inspection organic materials, a storage unit configured to store a plurality of reference images generated through an artificial neural network and corresponding to each of the plurality of organic materials, and a neural network processing unit configured to select a selection reference image corresponding to the inspection image by comparing the inspection image with the reference images, and output an organic material distribution image based on the selection reference image.

In an embodiment, the reference images may be generated by learning a comparison image for a comparison target including the plurality of organic materials through the artificial neural network.

In an embodiment, the comparison target may include a plurality of comparison targets, and the plurality of organic materials included in the plurality of comparison targets may be different in bonding structure.

In an embodiment, each of the inspection image and the comparison image may be generated using an energy dispersive spectroscopy (EDS).

In an embodiment, the artificial neural network may be a convolutional neural network.

In an embodiment, the plurality of reference images may be acquired based on the bonding type of the plurality of organic materials.

In an embodiment, the inspection device may further include a detection unit configured to determine the type of inspection organic materials included in the inspection target based on the organic material distribution image.

In an embodiment of the inventive concept, a method of inspection includes generating a plurality of reference images through an artificial neural network, outputting an inspection image for an inspection target including a plurality of inspection organic materials, selecting a selection reference image corresponding to the inspection image by comparing the inspection image with the reference images, and outputting an organic material distribution image based on the selection reference image.

In an embodiment, the generating of the reference images may include learning comparison images for a plurality of comparison targets including a plurality of organic materials through the artificial neural network.

In an embodiment, the comparison image may be generated using an energy dispersive spectroscopy (EDS).

In an embodiment, the method may further include determining the type of inspection organic materials included in the inspection target based on the organic material distribution image.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a block diagram of an inspection device according to an embodiment of the inventive concept;

FIG. 2A is a cross-sectional view of a portion of an inspection device according to an embodiment of the inventive concept;

FIG. 2B is a view enlarging region AA′ shown in FIG. 2A;

FIG. 3A is a view showing a process of storing reference images and reference data for an inspection device according to an embodiment of the inventive concept;

FIG. 3B is an enlarged view enlarging region CC′ shown in FIG. 3A;

FIG. 4A is a graph showing comparison data according to an embodiment of the inventive concept;

FIG. 4B is a view showing a comparison image according to an embodiment of the inventive concept;

FIG. 5 is a view showing an oxygen vacancy distribution image;

FIG. 6 is a perspective view of a display device according to an embodiment of the inventive concept;

FIG. 7 is an exploded perspective view of a display device according to an embodiment of the inventive concept;

FIG. 8 is a cross-sectional view of a display device according to an embodiment of the inventive concept;

FIG. 9A is a plan view of a display panel according to an embodiment of the inventive concept;

FIG. 9B is a cross-sectional view of a display panel according to an embodiment of the inventive concept;

FIG. 10 is a flowchart of a method of inspection according to an embodiment of the inventive concept;

FIG. 11 is a block diagram of an inspection device according to an embodiment of the inventive concept;

FIG. 12A is a cross-sectional view of a portion of an inspection device according to an embodiment of the inventive concept;

FIG. 12B is a view enlarging region FF′ shown in FIG. 2A;

FIG. 13A is a view showing a process of storing reference images and reference data of an inspection device according to an embodiment of the inventive concept;

FIG. 13B is a view enlarging region HH′ shown in FIG. 13A;

FIG. 13C is a view showing a comparison image according to an embodiment of the inventive concept;

FIG. 14A is a view showing a selection reference image according to an embodiment of the inventive concept;

FIG. 14B is a view showing an organic material distribution image according to an embodiment of the inventive concept;

FIGS. 15A to 15C are graphs showing a distribution map of organic materials included in an inspection target, using an inspection device according to an embodiment of the inventive concept; and

FIG. 16 is a flowchart of a method of inspection according to an embodiment of the inventive concept.

### DETAILED DESCRIPTION

The present disclosure may be modified in many alternate forms, and thus specific embodiments will be exemplified in the drawings and described in detail. It should be understood, however, that it is not intended to limit the present disclosure to the particular forms disclosed, but rather, is intended to cover all modifications, equivalents, and alternatives falling within the spirit and scope of the present disclosure.

As used herein, when an element (or a region, a layer, a portion, etc.) is referred to as being “on,” “connected to,” or “coupled to” another element, it means that the element may be directly disposed on/connected to/coupled to the other element, or that a third element may be disposed therebetween.

Like reference numerals refer to like elements. In addition, in the drawings, the thickness, the ratio, and the dimensions of elements are exaggerated for an effective description of technical contents.

The term “and/or,” includes all combinations of one or more of which associated configurations may define.

Although the terms first, second, etc. may be used herein to describe various elements, these elements should not be limited by these terms. These terms are only used to distinguish one element from another element. For example, a first element may be referred to as a second element, and similarly, a second element may be referred to as a first element without departing from the teachings of the present disclosure. The singular forms are intended to include the plural forms as well unless the context clearly indicates otherwise.

In addition, terms such as “below,” “lower,” “above,” “upper,” and the like are used to describe the relationship of the configurations shown in the drawings. The terms are used as a relative concept and are described with reference to the direction indicated in the drawings.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “includes” or “including”, when used in this specification, specify the presence of stated features, integers, steps, operations, elements, components, or a combination thereof, but do not preclude the presence or addition of one or more other features, integers, steps, operations, elements, components, or combinations thereof.

Hereinafter, embodiments of the inventive concept will be described with reference to the drawings.

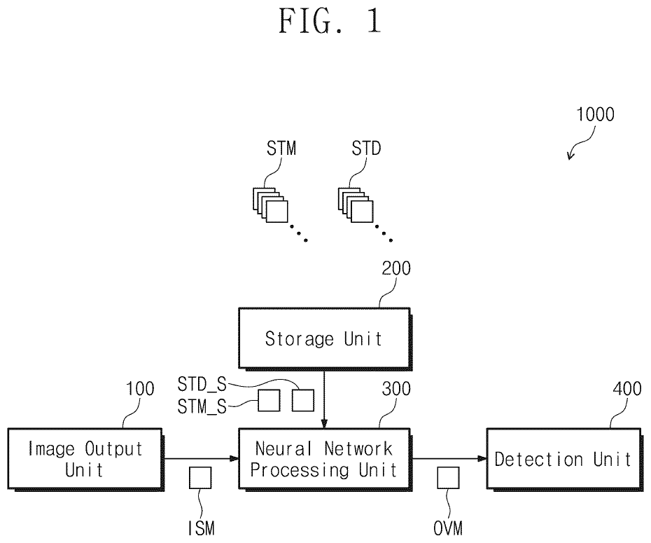

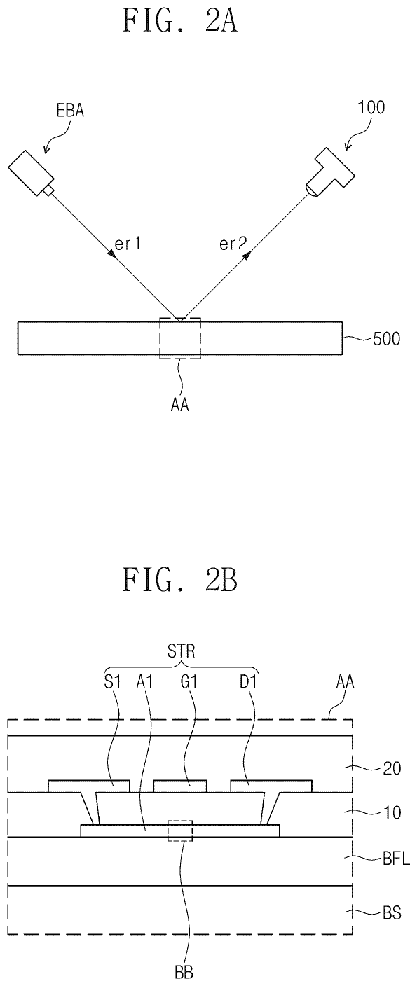

FIG. 1 is a block diagram of an inspection device according to an embodiment of the inventive concept. FIG. 2A is a cross-sectional view of a portion of an inspection device according to an embodiment of the inventive concept. FIG. 2B is a view enlarging region AA′ shown in FIG. 2A.

Referring to FIG. 1, an inspection device 1000 may include an image output unit 100, a storage unit 200, a neural network processing unit 300, and a detection unit 400. The inspection device 1000 may correspond to one of various types of inspection equipment for inspecting the oxygen vacancy distribution of an inspection target 500 (see FIG. 2A).

Referring to FIGS. 1 and 2A, the image output unit 100 may capture an inspection image ISM of the inspection target 500 and output the inspection image ISM to the neural network processing unit 300. According to an embodiment of the inventive concept, the image output unit 100 may include an image capture apparatus such as an energy dispersive spectroscopy (EDS). However, the embodiment of the inventive concept is not limited thereto, and the image output unit 100 may include a scanning electron microscope or a transmission electron microscope as a method of spectroscopy. A beam output unit EBA in the inspection device 1000 may provide an electron beam er1 to the inspection target 500. The electron beam er1 may be directly incident on the inspection target 500, and an emission rays er2, for example, X-rays, may be emitted from the inspection target 500.

When the electron beam er1 is directly incident on the inspection target 500, core electrons included in the inspection target 500 may be emitted from the inspection target 500. X-rays may be emitted from the inspection target 500 when valence electrons fill empty sites from which the core electrons are emitted. That is, the emission rays er2 may be an X-ray emitted when peripheral electrons fill the empty sites where the emitted core electrons were placed. The image output unit 100 may output the inspection image ISM obtained from the emission rays er2 corresponding to the inspection target 500 to the neural network processing unit 300. Specifically, the image output unit 100 may scan the emission rays er2 to detect elements inside the inspection target 500, and provide a cross-sectional view of the inspection target 500 as an SEM image through mapping analysis. The output inspection image ISM may be provided to the neural network processing unit 300.

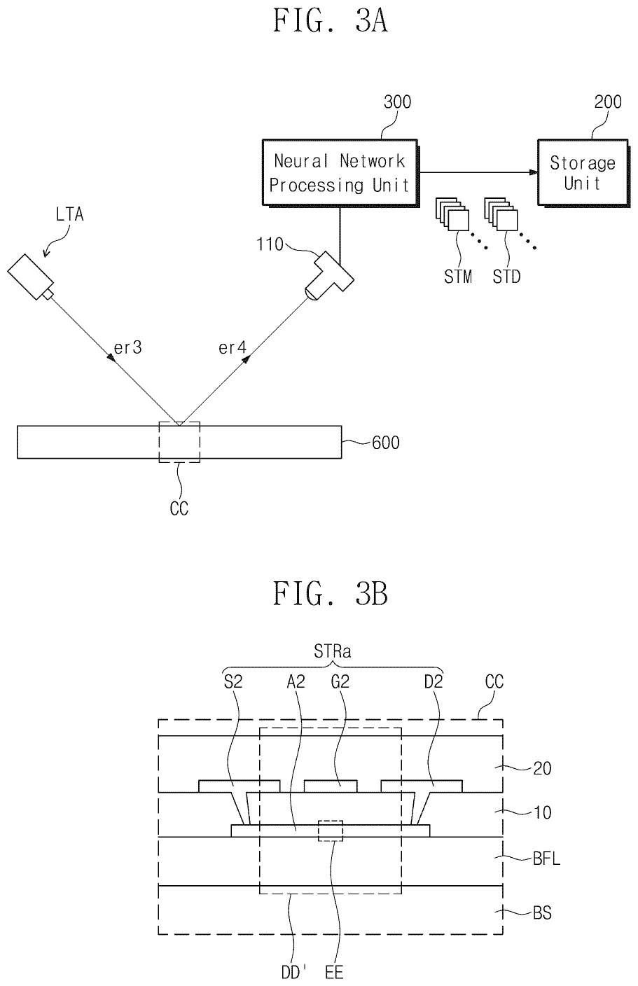

The storage unit 200 may store a plurality of reference images STM and a plurality of reference data STD corresponding to the plurality of reference images STM. The storage unit 200 may be a non-volatile memory device. The reference data STD may be data indicating oxygen vacancy distribution of comparison targets 600 (see FIG. 3A). Specifically, the distribution of oxygen vacancy present on a surface of the test target 500 may be converted into data to obtain the reference data STD. Alternatively, the reference data STD may also include a spectrum or a graph. The plurality of reference images STM may be acquired using samples having predetermined oxygen vacancy distributions. Specifically, the oxygen vacancy distribution of the test target 500 may vary according to oxygen vacancy concentration of the test target 500, and, in the storage unit 200, reference images STM according to predetermined oxygen vacancy distributions may be stored. The plurality of reference images STM and the plurality of reference data STD may be generated through repeated measurements or an artificial neural network. Details will be described later.

The neural network processing unit 300 may output an oxygen vacancy distribution image OVM for the inspection target 500. The neural network processing unit 300 may include a comparator which compares the plurality of reference images STM stored in the storage unit 200 with the inspection image ISM provided from the image output unit 100.

The neural network processing unit 300 may compare the plurality of reference images STM stored in the storage unit 200 with the inspection image ISM provided from the image output unit 100, and select one reference image STM_S (hereinafter referred to as a selection reference image) matched with or mostly similar to the inspection image ISM. Thereafter, the neural network processing unit 300 may output the oxygen vacancy distribution image OVM corresponding to the selection reference image STM_S from a selection reference data STD_S. The oxygen vacancy distribution image OVM corresponds to an image for an oxygen vacancy distribution map for a cross section of the inspection target 500.

The detection unit 400 may receive the oxygen vacancy distribution image OVM from the neural network processing unit 300. The detection unit 400 may include a comparator which compare the oxygen vacancy distribution image OVM with a predetermined distribution setting value. The detection unit 400 may detect whether the oxygen vacancy distribution of the inspection target 500 is defective by comparing the oxygen vacancy distribution image OVM received from the neural network processing unit 300 with a predetermined distribution setting value. Specifically, the oxygen vacancy refers to a vacancy of an oxygen atom in an oxide structure which serves as a charge carrier for electrical conduction. When the inside of the inspection target 500 including an oxide semiconductor has an irregular distribution of oxygen vacancy, the oxide semiconductor may exhibit deteriorated electrical properties due to reduced charge mobility. Therefore, the detection unit 400 may detect whether the inspection target 500 is defective based on the oxygen vacancy distribution for the cross section of the inspection target 500 and a concentration of oxygen vacancy included in the oxide semiconductor by using the provided oxygen vacancy distribution image OVM.

Referring to FIG. 2B, the inspection target 500 may include a base layer BS and an oxide semiconductor transistor STR. The base layer BS may be disposed at a lowermost end of the inspection target 500. The base layer BS may be a synthetic resin layer including a synthetic resin. The synthetic resin layer may include a thermosetting resin. In particular, the synthetic resin layer may be a polyimide-based resin layer, and the material is not particularly limited. The synthetic resin layer may include at least any one among an acrylic-based resin, a methacrylate-based resin, a polyisoprene-based resin, a vinyl-based resin, an epoxy-based resin, a urethane-based resin, a cellulose-based resin, a siloxane-based resin, a polyamide-based resin, or a perylene-based resin. In addition, the base layer BS may include a glass substrate, a metal substrate, or an organic/inorganic composite material substrate.

The inspection target 500 may further include a buffer layer BFL disposed on the base layer BS. The buffer layer BFL may be disposed on the base layer BS to cover a lower gate (not shown). The buffer layer BFL increases a bonding force between the base layer BS and semiconductor patterns and/or conductive patterns. The buffer layer BFL may be an inorganic layer. According to an embodiment, the buffer layer BFL may include a multi-layer structure. For example, the buffer layer BFL may include a silicon oxide layer and a silicon nitride layer. The silicon oxide layer and the silicon nitride layer may be alternately stacked.

An oxide semiconductor pattern A1 may be disposed on the buffer layer BFL. The oxide semiconductor pattern A1 may include a metal oxide semiconductor. The metal oxide semiconductor may include a crystalline or amorphous oxide semiconductor. For example, the metal oxide semiconductor may include a metal oxide including zinc (Zn), indium (In), gallium (Ga), tin (Sn), titanium (Ti), or a mixture of metals such as zinc (Zn), indium (In), gallium (Ga), tin (Sn), and titanium (Ti) and an oxide thereof. The metal oxide semiconductor may include indium-tin oxide (ITO), indium-gallium-zinc oxide (IGZO), zinc oxide (ZnO), indium-zinc oxide (IZnO), zinc-indium oxide (ZIO), indium oxide (InO), titanium oxide (TiO), indium-zinc-tin oxide (IZTO), zinc-tin oxide (ZTO), and the like.

A first insulating layer 10 may be disposed on the buffer layer BFL. The first insulating layer 10 may be an inorganic layer and/or an organic layer, and have a single-layered or multi-layered structure. The first insulating layer 10 may cover the oxide semiconductor pattern A1 on the buffer layer BFL.

The source electrode S1 and the drain electrode D1 may be disposed on the first insulating layer 10. Each of the source electrode S1 and the drain electrode D1 may be connected to the oxide semiconductor pattern A1 through a contact hole formed in the first insulating layer 10.

A gate G1 may be disposed on the first insulating layer 10. The gate G1 may be disposed between the source electrode S1 and the drain electrode D1 and may overlap the oxide semiconductor pattern A1. The gate G1 is a conductive pattern and may be connected to another electrode to independently receive a constant voltage or a pulse signal. Alternatively, the gate G1 may be provided in a form isolated from other conductive patterns. The gate G1 according to an embodiment of the inventive concept may be provided in various forms and is not limited to any one embodiment.

A second insulating layer 20 covering the gate G1, the source electrode S1, and the drain electrode D1 may be disposed on the first insulating layer 10. According to an embodiment of the inventive concept, the second insulating layer 20 may be an organic layer and may have a single-layered structure, but is not particularly limited.

Referring to FIGS. 1 and 2B together, a region corresponding to the inspection image ISM may be a BB′ region. The BB′ region may be a partial region of the oxide semiconductor transistor STR. For example, the BB′ region may be a portion of the oxide semiconductor pattern A1. The electron beam er1 may be provided to the BB′ region of the inspection target 500, and the emission rays er2 emitted from the BB′ region may be provided to the image output unit 100. The image output unit 100 may scan the emission rays er2 to provide the inspection image ISM corresponding to the BB′ region of the inspection target 500. That is, the inspection image ISM may be a cross-sectional view corresponding to a partial region of the oxide semiconductor transistor STR, specifically, a portion of the oxide semiconductor pattern A1. An area of the BB′ region in a cross-sectional view may be about 900 nm² to about 1600 nm².

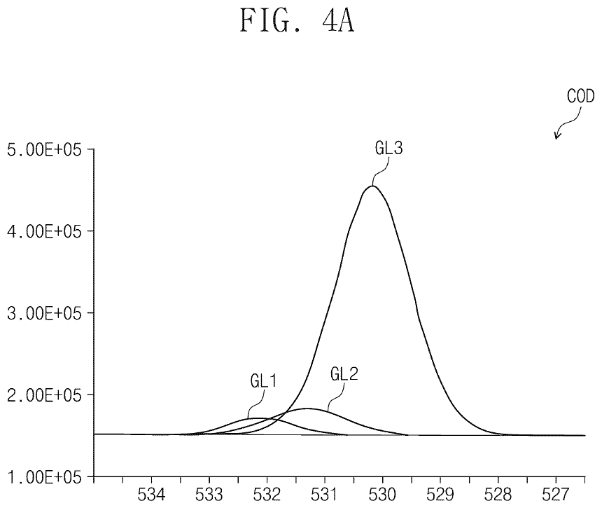

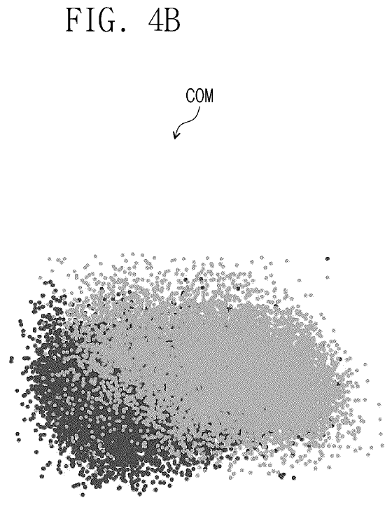

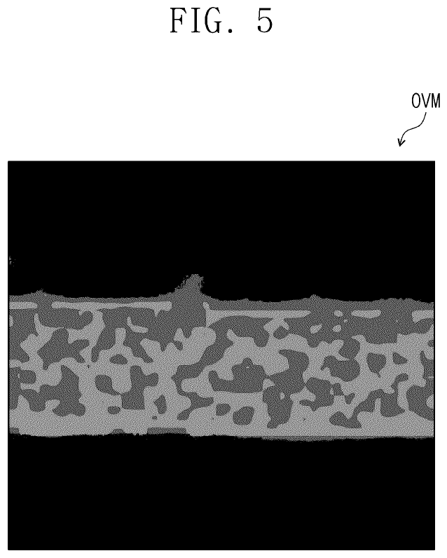

FIG. 3A is a view showing a process of storing reference images and reference data for an inspection device according to an embodiment of the inventive concept. FIG. 3B is an enlarged view enlarging region CC′ shown in FIG. 3A. FIG. 4A is a graph showing comparison data according to an embodiment of the inventive concept. FIG. 4B is a view showing a comparison image according to an embodiment of the inventive concept. Hereinafter, a process of generating the reference image STM and reference data STD will be described in detail with reference to FIGS. 3A to 4B.

Referring to FIG. 3A, the data output unit 110 may output comparison data COD (see FIG. 4A) obtained from a comparison target 600. According to an embodiment of the inventive concept, the comparison data COD may be generated using X-ray photoelectron spectroscopy (XPS). A light source LTA may provide light er3 to the comparison target 600. The light er3 may be directly incident on the comparison target 600, and an emission electron er4 may be emitted from the comparison target 600 and provided to the data output unit 110.

X-ray photoelectron spectroscopy is a method of surface-sensitive quantitative spectroscopy based on a photoelectric effect, which may also identify elements present in a substance or covering a surface of a substance, and chemical states, an overall electronic structure, and the density of electronic states of a material. The light er3 may be an X-ray beam. The comparison target 600 may be irradiated with an X-ray beam injected from the light source LTA, and photoelectrons may thus be emitted from the comparison target 600 by the injected X-ray beam. That is, the emitted electron er4 may be a photoelectron emitted from the comparison target 600 toward outside of the comparison target 600. Specifically, when the comparison target 600 is irradiated, electrons of a strongly bonded core level or a weakly bonded valence level are emitted from atoms constituting the comparison target 600. In this case, the emitted electrons are photoelectrons. In order to emit photoelectrons, kinetic energy exceeding the binding energy and work function of electrons is provided to the comparison target 600. Therefore, when the kinetic energy of the emitted photoelectron is measured, the binding energy of an electron corresponding to the material is determined, and this may allow a bonding relationship and composition of the bonded elements to be identified. The data output unit 110 may output comparison data COD based on the identified information.

Referring to FIGS. 2B and 3B together, the comparison target 600 may have the same structure as the inspection target 500. The comparison target 600 may include a base layer BS and an oxide semiconductor transistor STRa. The oxide semiconductor transistor may include an oxide semiconductor pattern A2. The oxide semiconductor transistor STRa may include a metal oxide semiconductor. The metal oxide semiconductor may include a crystalline or amorphous oxide semiconductor. The oxide semiconductor transistor STRa may have the same components as the oxide semiconductor transistor STR shown in FIG. 2B.

A region corresponding to the comparison data COD may be a DD′ region. The DD′ region may include a partial region of the oxide semiconductor pattern A2. For example, the DD′ region may include a gate G2 and may further include a portion of a source electrode S2 and a drain electrode D2. The light er3 may be provided to the DD′ region of the comparison target 600, and the emission electrons er4 emitted from the DD′ region may be provided to the data output unit 110. The data output unit 110 may provide comparison data COD corresponding to the DD′ region of the comparison target 600 based on the emission electrons er4. An area of the DD′ region in a cross-sectional view may be about 25 μm² to about 30 μm². According to an embodiment of the inventive concept, a light source LTA may be disposed to emit light having a predetermined angle with respect a surface of the comparison target 600. When the light source LTA is disposed to emit light having a right angle with respect to the surface of the comparison target 600, a region in a cross-sectional view that may be inspected may be about 100 nm² or less, but as the light source LTA is disposed to emit light tilted at a predetermined angle with respect to the surface of the comparison target 600, the region in a cross-sectional view that may be inspected may be set to about 25 μm² to about 30 μm².

FIG. 4A is a graph showing results obtained by analyzing the DD′ region shown in FIG. 3B as comparison data COD through X-ray photoelectron spectroscopy. Specifically, the graph is a graph showing a ratio of oxygen bonds to oxygen ion-related chemical bonds O1s in the DD′ region of the comparison target 600 through X-ray photoelectron spectroscopy. The x-axis of the graph indicates the binding energy of oxygen, and the y-axis indicates oxygen peak intensity, that is, the number of electrons having energy levels.

When the X-ray photoelectron spectroscopy is applied, an energy spectrum of the oxygen ion-related chemical bond O1s may include an M-OH binding energy spectrum, an M-O binding energy spectrum, and a binding energy by oxygen vacancy spectrum. That is, the distribution and concentration of oxygen vacancy may be indicated according to a first graph GL1, a second graph GL2, and a third graph GL3.

Referring to FIG. 4A, the first graph GL1 is a graph showing an energy spectrum for M(metal)-OH among the oxygen bonds of the comparison target 600. The first graph GL1 shows that the M-OH bonding level has a peak value at 532.5 eV. The second graph GL2 is a graph showing an energy spectrum for oxygen vacancy among the oxygen bonds of the comparison target 600. The second graph GL2 shows that the oxygen vacancy bonding level has a peak value at 531.5 eV. The third graph GL3 is a graph showing an energy spectrum for M (metal)-O among the oxygen bonds of the comparison target 600. The third graph GL3 shows that the M-O binding level has a peak value at 530.0 eV.

An area of each of the first graph GL1, the second graph GL2, and the third graph GL3 indicates a binding fraction. The area of the second graph GL2 may be equal to the concentration of oxygen vacancy. Therefore, the concentration of oxygen vacancy in the DD′ region of the comparison target 600 may be obtained through the second graph GL2.

Referring to FIG. 4B, the comparison image COM may be an image showing a cross-section of the comparison target 600 (see FIG. 3A). Specifically, the comparison image COM may be an image showing a cross-section of the comparison target 600 as a distribution map of zinc (Zn), indium (In), gallium (Ga), and oxygen (O). According to an embodiment of the inventive concept, the comparison image COM may be generated using energy dispersive spectroscopy (EDS). However, the embodiment of the inventive concept is not limited thereto, and the comparison image COM may be generated using a scanning electron microscope or a transmission electron microscope as a method of spectroscopy. That is, the comparison image COM may be generated in the same manner as the inspection image ISM described with reference to FIG. 2A. A plurality of comparison images COM may be provided. A plurality of comparison objects 600 may be provided, and correspondingly, a plurality of comparison images COM for the comparison target 600 may be provided. The generated plurality of comparison images COM may be provided to the neural network processing unit 300 shown in FIG. 3A.

Referring to FIG. 3B together with FIG. 4B, a region corresponding to the comparison image COM may be an EE′ region. The EE′ region may include a partial region of the oxide semiconductor transistor STRa. For example, the EE′ region may include a portion of the oxide semiconductor pattern A2. The comparison image COM corresponds to a portion of the oxide semiconductor pattern A2 and may thus correspond to data for generating the reference image STM (see FIG. 3A). An area of the EE′ region in a cross-sectional view may be about 900 μm² to about 1600 μm². The DD′ region may be about 30000 times the EE′ region.

Referring back to FIG. 3A, the neural network processing unit 300 may generate a plurality of reference images STM and a plurality of reference data STD using the plurality of comparison images COM and the plurality of comparison data COD corresponding thereto. The plurality of reference images STM and the plurality of reference data STD may be generated using an algorithm. The algorithm may include artificial intelligence (AI) that mimics the way humans think. The artificial intelligence may include algorithms such as machine learning and deep learning. For example, the algorithm may use a convolutional neural network (CNN) as one of the deep learning algorithms.

The characteristics of oxygen vacancy distribution may be extracted through the plurality of comparison images COM and the plurality of comparison data COD provided to the neural network processing unit 300. A process (or artificial intelligence learning) of extracting common patterns from the plurality of comparison images COM and matching the comparison data COD for predicting oxygen vacancy distribution corresponding thereto may be performed. Through the learning described above, the neural network processing unit 300 may generate data for predicting a specific oxygen vacancy distribution according to a specific image. The plurality of reference images STM according to an embodiment of the inventive concept are the specific images, and the plurality of reference data STD correspond to data for predicting a specific oxygen vacancy distribution. The plurality of reference images STM and the plurality of reference data STD generated through the learning algorithm may be stored in the storage unit 200, and then used to predict the oxygen vacancy distribution of the inspection target 500 (see FIG. 2A).

FIG. 5 is a view showing an oxygen vacancy distribution image.

Referring to FIG. 5, an oxygen vacancy distribution image OVM shows an oxygen vacancy distribution of a portion corresponding to a portion of the inspection target 500 (see FIG. 2A). Specifically, it is an image showing the oxygen vacancy distribution of a portion corresponding to the BB′ region of the oxide semiconductor transistor STR shown in FIG. 2B. The reference data STD (see FIG. 1) is data showing the oxygen vacancy distribution, and the oxygen vacancy distribution image OVM may be generated by imaging the reference data STD. The oxygen vacancy distribution for a specific portion of the inspection target 500 may be easily determined through the oxygen vacancy distribution image OVM.

Referring to FIGS. 1 to 5, the inspection device 1000 may obtain the oxygen vacancy distribution image OVM determining the oxygen vacancy distribution of a fine semiconductor region (specifically, the BB′ region) of the inspection target 500 including an oxide semiconductor, through the plurality of reference images STM and the plurality of reference data STD obtained from the comparison target 600 including an oxide semiconductor. Accordingly, a reliable inspection device 1000 may be provided.

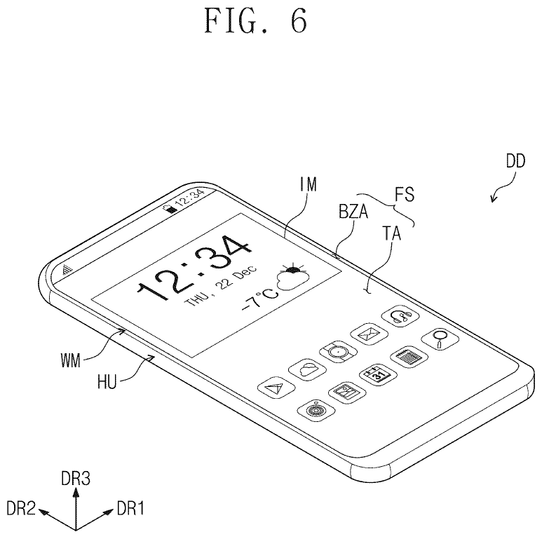

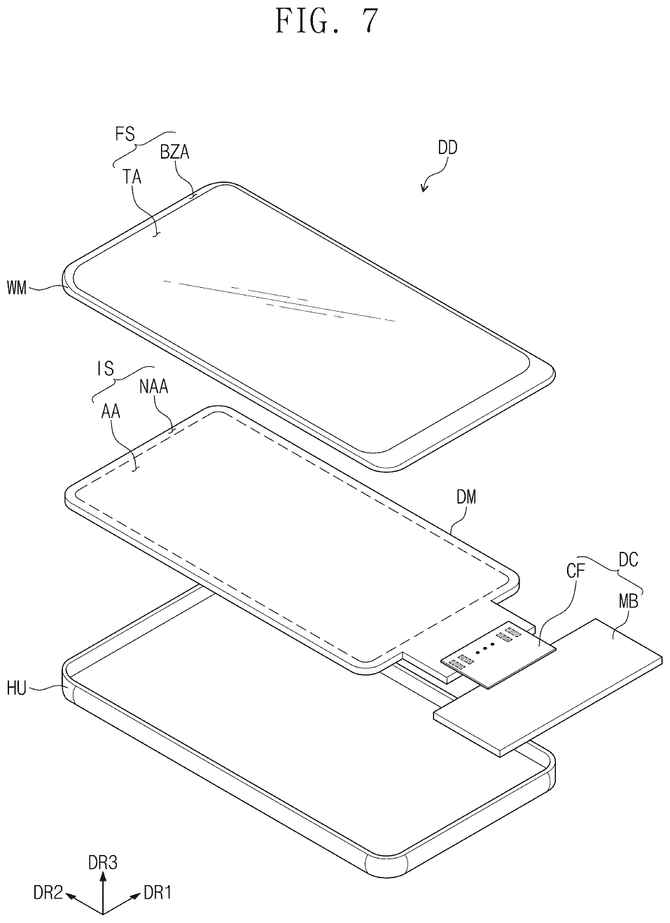

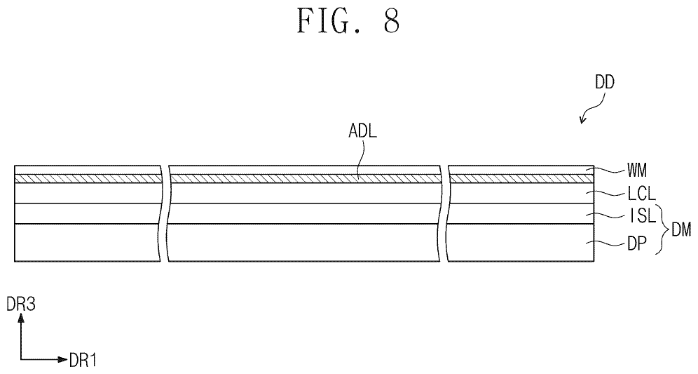

FIG. 6 is a perspective view of a display device according to an embodiment of the inventive concept. FIG. 7 is an exploded perspective view of a display device according to an embodiment of the inventive concept. FIG. 8 is a cross-sectional view of a display device according to an embodiment of the inventive concept.

Referring to FIG. 6, a display device DD may be a device activated according to electrical signals. The display device DD may include various embodiments. For example, the display device DD may be applied to electronic devices such as a mobile phone, a smart watch, a tablet, a laptop, a computer, and a smart television. The display device DD according to an embodiment of the inventive concept is not limited to the above examples, and other electronic devices may be employed as long as not departing from the inventive concept. In the present embodiment, the display device DD is shown as a mobile phone by way of example.

The display device DD may display an image IM toward a third direction DR3 on a display surface FS parallel to a plane formed by a first direction DR1 and a second direction DR2. The image IM may include still images as well as dynamic images. In FIG. 6, a watch and icons are shown as an example of the image IM. The display surface FS on which the image IM is displayed may correspond to a front surface of the display device DD and also may correspond to a front surface of a window WM.

In the present embodiment, a front surface (or an upper surface) and a rear surface (or a lower surface) of respective members are defined with respect to a direction in which the image IM is displayed. Front and rear surfaces may oppose each other in the third direction DR3 and a normal direction of each of the front and rear surfaces may be parallel to the third direction DR3. The distance between the front surface and the rear surface in the third direction DR3 may correspond to a thickness defined along the third direction DR3 of the display device DD. As used herein, “when viewed on a plane” or “in a plan view” may indicate a state viewed in the third direction DR3. Meanwhile, directions indicated by the first to third directions DR1, DR2, and DR3 are relative concepts, and may thus be changed to other directions.

Referring to FIGS. 6 and 7, the display device DD may include a window WM, a display module DM, a driving circuit DC, and a housing HU. The window WM and the housing HU may be bonded to form an outer portion of the display device DD.

The window WM may include an optically transparent insulating material. For example, the window WP may include glass or plastic. The window WM may have a multi-layer structure or a single-layer structure. For example, the window WM may include a plurality of plastic films bonded through an adhesive, or a glass substrate and a plastic film, which are bonded through an adhesive.

As described above, the front surface of the window WM may define the display surface FS of the display device DD. The transmission region TA may be an optically transparent region. For example, the transmission region TA may be a region having a visible light transmittance of about 90% or greater.

The bezel region BZA may be a region having a relatively lower light transmittance than the transmission region TA. The bezel region BZA may define a shape of the transmission region TA. The bezel region BZA may be disposed adjacent to the transmission region TA and may surround the transmission region TA.

The bezel region BZA may have a predetermined color. Meanwhile. This is merely presented as an example and the bezel region BZA may be omitted in the window WP according to an embodiment of the inventive concept.

The display module DM may display the image IM and detect external inputs. The display module DM may include a front surface IS including an active region AA and a peripheral region NAA. The active region AA may be a region activated according to electrical signals.

In the present embodiment, the active region AA may be a region in which the image IM is displayed and also external inputs are detected. The transmission region TA may overlap at least a portion of the active region AA. For example, the transmission region TA may overlap all or at least a portion of the active region AA.

Accordingly, users may view the image IM through the transmission region TA or provide external inputs. However, this is merely presented as an example, and, in the display module DM according to an embodiment of the inventive concept, a region in which the image IM is displayed and a region in which external inputs are detected may be separated in the active region AA, and the embodiment of the inventive concept is not limited to any one embodiment.

The peripheral region NAA may be disposed adjacent to the active region AA. The peripheral region NAA may surround the active region AA. A driving circuit, a driving line, or the like for driving the active region AA may be disposed in the peripheral region NAA. The bezel region BZA may cover the peripheral region NAA to prevent the peripheral region NAA from being viewed from the outside.

The driving circuit DC may include a flexible circuit board CF and a main circuit board MB. The flexible circuit board CF may be electrically connected to the display module DM. The flexible circuit board CF may connect the display module DM and the main circuit board MB. However, this is shown as an example, and the flexible circuit board CF according to an embodiment of the inventive concept may not be connected to a separate circuit board.

The flexible circuit board CF may be connected to pads of the display module DM disposed in the peripheral region NAA. The flexible circuit board CF may provide electrical signals for driving the display module DM to the display module DM. The electrical signals may be generated in the flexible circuit board CF or in the main circuit board MB.

The main circuit board MB may include various driving circuits for driving the display module DM or a connector for supplying power. The main circuit board MB may be connected to the display module DM through the flexible circuit board CF.

The housing HU may be bonded to the window WM. The housing HU may be bonded to the window WM to provide a predetermined interior space. The display module DM may be accommodated in the interior space.

The housing HU may include a material having relatively high rigidity. For example, the housing HU may include glass, plastic, or metal or may include a plurality of frames and/or plates having a combination of glass, plastic, and metal. The housing HU may stably protect components of the display device DD, which are accommodated in the internal space, against external shocks.

FIG. 8 is a cross-sectional view of a display device according to an embodiment of the inventive concept. In FIG. 8, the display device DD is simply shown to describe the stacking relationship of functional panels and/or functional units constituting the display device DD.

The display device DD according to an embodiment may include a display module DM, a light control layer LCL, and a window WM. The display module DM may include a display panel DP and an input sensor ISL.

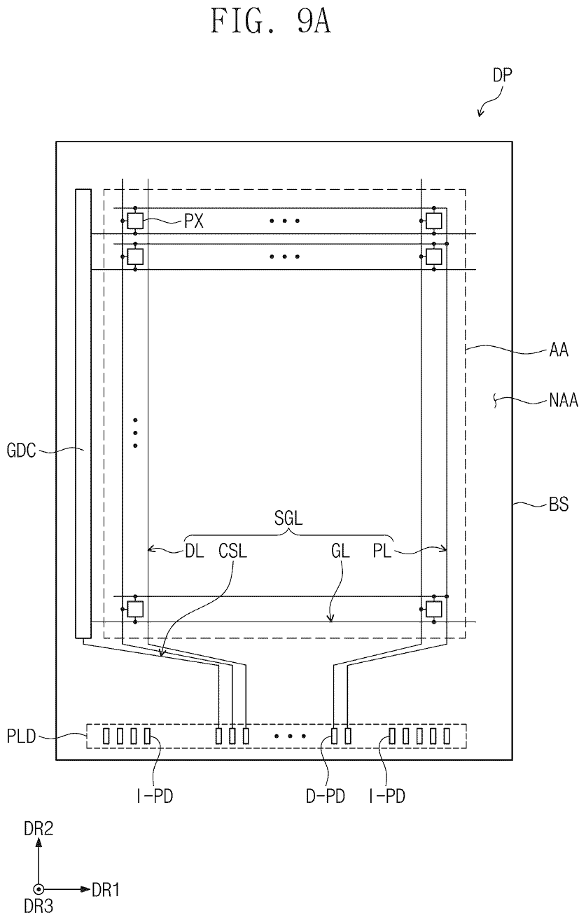

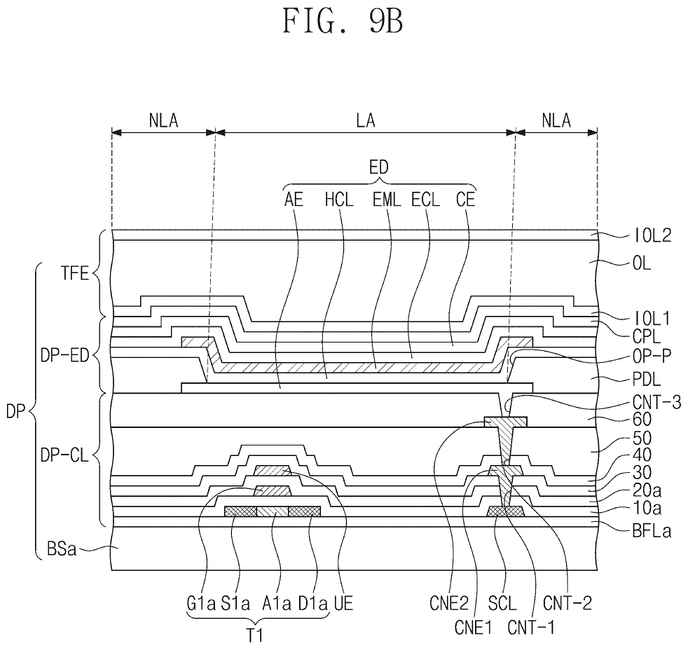

The display panel DP generates images. The display panel DP includes a plurality of pixels PX (see FIG. 9A). The display panel DP according to an embodiment may be a light emitting display panel including a light emitting element as a display element, but is not particularly limited thereto. For example, the display panel DP may be an organic light emitting display panel or an inorganic light emitting display panel. An emission layer of the organic light emitting display panel may include an organic light emitting material. An emission layer of the inorganic light emitting display panel may include quantum dots, quantum rods, or inorganic LEDs. Hereinafter, the display panel DP will be described as an organic light emitting display panel.

The input sensor ISL is disposed on the display panel DP. The input sensor ISL obtains coordinate information of external inputs (e.g., a touch event). The input sensor ISL may detect external inputs in a capacitive mode.

The light control layer LCL may be disposed on the input sensor ISL. The light control layer LCL may control a path of light (hereinafter, referred to as source light) generated from the display panel DP. The light control layer LCL may collect source light generated from a partial region of the display panel DP. In addition, the light control layer LCL may reduce reflectance of natural light (or sunlight) incident to the display panel DP from an upper side of the window WM.

The light control layer LCL may not include a polarizing layer. Accordingly, natural light passing through the light control layer LCL and incident to the display panel DP and the input sensor ISL may be unpolarized light. The display panel DP and the input sensor ISL may receive unpolarized natural light from an upper portion of the light control layer LCL.

The window WM is disposed on the light control layer LCL. The window WM and the light control layer LCL may be bonded through a window adhesive layer ADL. The window adhesive layer ADL may be a pressure sensitive adhesive film (PSA) or an optically clear adhesive (OCA).

FIG. 9A is a plan view of a display panel according to an embodiment of the inventive concept. FIG. 9B is a cross-sectional view of a display panel according to an embodiment of the inventive concept.

Referring to FIG. 9A, the display panel DP may include a base layer BS including the active region AA and the peripheral region NAA described above.

The display panel DP may include pixels PX disposed in the active region AA, and signal lines SGL electrically connected to the pixels PX. The display panel DP may include an integrated driving circuit GDC and a pad portion PLD, which are disposed in the peripheral region NAA.

The pixels PX may be arranged in the first direction DR1 and the second direction DR2. The pixels PX may include a plurality of pixel rows extending in the first direction DR1 and arranged in the second direction DR2 and a plurality of pixel columns extending in the second direction DR2 and arranged in the first direction DR1.

The signal lines SGL may include gate lines GL, data lines DL, a power line PL, and a control signal line CSL. The gate lines GL may each be connected to a corresponding pixels among the pixels PX, and the data lines DL may each be connected to a corresponding pixels among the pixels PX. The power line PL may be electrically connected to the pixels PX. The control signal line CSL may be connected to the integrated driving circuit GDC to provide control signals to the integrated driving circuit GDC.

The integrated driving circuit GDC may include a gate driving circuit. The gate driving circuit may generate gate signals and sequentially output the generated gate signals to the gate lines GL. The gate driving circuit may further output another signal (e.g., an emission control signal) to the pixels PX.

The pad portion PLD may be a portion to which the flexible circuit board CF described in FIG. 7 is connected. The pad portion PLD may include pixel pads D-PD and input pads I-PD.

The pixel pads D-PD may be pads for electrically connecting the flexible circuit board FCB to the display panel DP. The pixel pads D-PD may each be connected to a corresponding signal line among the signal lines SGL. The pixel pads D-PD may be connected to corresponding pixels PX through the signal lines SGL. In addition, any one of the pixel pads D-PD may be connected to the integrated driving circuit GDC.

The input pads I-PD may be pads for connecting the flexible circuit board CF to the input sensor ISL (see FIG. 8). Although FIG. 9A shows that the input pads I-PD are disposed on the display panel DP, the embodiment of the inventive concept is not limited thereto, and the input pads I-PD may be disposed in the input sensor ISL and connected to a circuit board through pads in the input sensor ISL.

Referring to FIG. 9B, the display panel DP may include a base layer BSa, a circuit element layer DP-CL, a display element layer DP-ED, and an encapsulation layer TFE.

The base layer BSa may include a synthetic resin film. In addition, the base layer BSa may include a glass substrate, a metal substrate, an organic/inorganic composite material substrate, or the like.

The display panel DP may include a plurality of insulating layers, a semiconductor pattern, a conductive pattern, and a signal line. An insulating layer, a semiconductor layer, and a conductive layer may be formed through processes such as coating or deposition. Thereafter, the insulating layer, the semiconductor layer, and the conductive layer may be selectively patterned through photolithography and etching. Semiconductor patterns, conductive patterns, signal lines, and the like included in the circuit element layer DP-CL and the display element layer DP-ED may be formed through such processes described above.

A buffer layer BFLa is disposed on an upper surface of the base layer BSa. The buffer layer BFLa may improve a bonding force between the base layer BSa and semiconductor patterns. The buffer layer BFLa may include a silicon oxide layer and a silicon nitride layer. The silicon oxide layer and the silicon nitride layer may be alternately stacked.

The semiconductor pattern is disposed on the buffer layer BFLa. The semiconductor pattern may include polysilicon. However, the embodiment of the inventive concept is not limited thereto, and the semiconductor pattern may include amorphous silicon or a metal oxide.

The semiconductor pattern may be arranged by specific rules over the buffer layer BFLa. The semiconductor pattern has different electrical properties according to a doping level. The semiconductor pattern may include a first region having a high doping concentration and a second region having a low doping concentration. The first region may be doped with an N-type dopant or a P-type dopant. A P-type transistor may include the first region doped with the P-type dopant.

The first region has greater conductivity than the second region, and substantially serves as an electrode or a signal line. The second region substantially corresponds to a channel region of a transistor. That is, a portion of the semiconductor pattern may be a channel region of the transistor, another portion may be a source or drain region of the transistor, and the other portion may be a conductive region.

As shown in FIG. 9B, a source region S1a, a channel region A1a, and a drain region D1a of the transistor T1 are formed from the semiconductor pattern. A portion of a signal transmission region SCL formed from the semiconductor pattern is shown in FIG. 9B. Although not shown separately, the signal transmission region SCL may be connected to the drain region D1a of the transistor T1 when in a plan view. The inspection device 1000 (see FIG. 1) according to an embodiment of the inventive concept may correspond to inspection equipment capable of inspecting the distribution of oxygen vacancy included in the channel region A1a. That is, the reliable display device DD (see FIG. 6) may be provided by examining the distribution of oxygen vacancy included in the channel region A1a and adjusting the concentration and distribution of oxygen vacancy to exhibit suitable electrical properties.

A first insulating layer 10a to a sixth insulating layer 60 are disposed on the buffer layer BFLa. The first insulating layer 10a to the sixth insulating layer 60 may be an inorganic layer or an organic layer. A gate G1 is disposed on the first insulating layer 10a. An upper electrode UE may be disposed on the second insulating layer 20a. A first connection electrode CNE1 may be disposed on the third insulating layer 30. The first connection electrode CNE1 may be connected to the signal transmission region SCL through a contact hole CNT-1 that is formed through the first to third insulating layers 10a to 30. The fourth insulating layer 40 and the fifth insulating layer 50 may be disposed on the third insulating layer 30. According to an embodiment, the fourth insulating layer 40 may be an inorganic layer and the fifth insulating layer 50 may be organic layer.

A second connection electrode CNE2 may be disposed on the fifth insulating layer 50. The second connection electrode CNE2 may be connected to the first connection electrode CNE1 through a contact hole CNT-2 that is formed through the fourth insulating layer 40 and the fifth insulating layer 50.

The display element layer DP-ED may be disposed on the circuit element layer DP-CL. According to the present embodiment, the display element layer DP-ED may include a light emitting element ED, a pixel defining layer PDL, and a capping layer CPL.

The light emitting element ED is disposed on the sixth insulating layer 60. According to the present embodiment, the light emitting element ED may include a first electrode AE, a hole control layer HCL, an emission layer EML, an electron control layer ECL, and a second electrode CE.

The first electrode AE is disposed on the sixth insulating layer 60. The first electrode AE is connected to the second connection electrode CNE2 through a contact hole CNT-3 that is formed through the sixth insulating layer 60. The pixel defining film PDL is disposed on the sixth insulating layer 60. A pixel opening OP-P is defined in the pixel defining film PDL. The pixel opening OP-P exposes at least a portion of the first electrode AE. Substantially, the light emitting region LA may be defined to correspond to the first electrode exposed through the pixel opening OP-P of the first electrodes AE. The non-light emitting region NLA corresponds to a region excluding the light emitting region LA in the active region AA (see FIG. 7).

In an embodiment, the pixel defining film PDL may include a light absorbing material. The pixel defining film PDL may include a black coloring agent. The black coloring agent may include a black dye and a black pigment. The black coloring agent may include carbon black, a metal such as chromium, or an oxide thereof.

The hole control layer HCL is disposed on the first electrode AE. The hole control layer HCL may be commonly disposed in the light emitting region LA and the non-light emitting region NLA. The hole control layer HCL may include a hole transport layer, and may further include a hole injection layer.

The emission layer EML is disposed on the hole control layer HCL. The emission layer EML may be disposed in a region corresponding to the pixel opening OP-P. That is, the emission layer EML may be disposed to correspond to the light emitting region LA.

The electron control layer ECL is disposed on the emission layer EML. The electron control layer ECL may include an electron transport layer and may further include an electron injection layer. The second electrode CE is disposed on the electron control layer ECL. The electronic control layer ECL and the second electrode CE may be commonly disposed in the light emitting region LA and the non-light emitting region NLA.

The capping layer CPL is disposed on the second electrode CE. The capping layer CPL may be commonly disposed in the light emitting region LA and the non-light emitting region NLA.

According to one embodiment, the capping layer CPL may include an inorganic material. The capping layer CPL may be formed through a sputtering deposition process.

The capping layer CPL covers the second electrode CE, and may thus protect the second electrode CE and the emission layer EML against external moisture or contamination. In addition, light totally reflected at an interface between the second electrode CE and the capping layer CPL may be reduced by adjusting a refractive index and a thickness of the capping layer CPL.

The encapsulation layer TFE is disposed on the capping layer CPL. The encapsulation layer TFE may be a thin film encapsulation layer. A single layer or a plurality of layers may be stacked on the encapsulation layer TFE. The encapsulation layer TFE includes at least one organic layer.

According to an embodiment, the encapsulation layer TFE may include a first inorganic layer IOL1, an organic layer OL, and a second inorganic layer IOL2. The first inorganic layer IOL1 may be disposed on the capping layer CPL. The organic layer OL may be disposed on the first inorganic layer IOL1. The second inorganic layer IOL2 may be disposed on the organic layer OL and may cover the organic layer OL.

The first inorganic layer IOL1 and the second inorganic layer IOL2 may protect the display element layer DP-ED against moisture/oxygen, and the organic layer OL may protect the display element layer DP-ED against foreign substances such as dust particles.

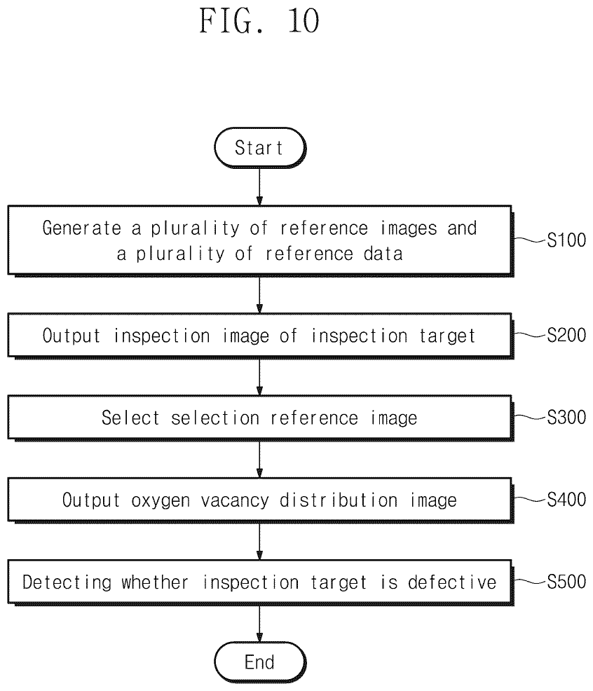

FIG. 10 is a flowchart of a method of inspection according to an embodiment of the inventive concept. Hereinafter, a method of inspection according to an embodiment of the inventive concept will be described with reference to FIGS. 1 to 10.

A neural network processing unit 300 may generate a plurality of reference images STM and a plurality of reference data STD (S100). The plurality of reference images STM and the plurality of reference data STD may be generated through a step of learning a plurality of comparison data COD and a plurality of comparison images COM obtained from a comparison target 600.

The plurality of comparison images COM may be generated using energy dispersive spectroscopy (EDS) for an EE′ region of the comparison target 600 shown in FIG. 3B. The EE′ region may include a portion of an oxide semiconductor transistor STRa, specifically, a portion of an oxide semiconductor pattern A2. An area of the EE′ region in a cross-sectional view is about 900 nm² to about 1600 nm², and the comparison image COM may be provided as a cross-sectional image corresponding to a portion of the oxide semiconductor pattern A2.

The plurality of comparison data COD may be generated using X-ray photoelectron spectroscopy (XPS) for a DD′ region of the comparison target 600 shown in FIG. 4B. The DD′ region may include a partial region of the oxide semiconductor transistor STRa. For example, the DD′ region may include a gate G2, and may include a portion of a source electrode S2, a drain electrode D2, and an oxide semiconductor pattern A2. An area of the DD′ region in a cross-sectional view is about 25 μm² to about 30 μm², and the comparison data COD may provide information about oxygen vacancy distribution to a portion of the oxide semiconductor pattern A2, the gate G2, the source electrode S2, and the drain electrode D2 as data. When generating the comparison data COD, the light source LTA shown in FIG. 3A may be disposed to emit light having a predetermined angle with respect to a surface of the comparison target 600. When the light source LTA is disposed to emit light having a right angle with respect to the surface of the comparison target 600, a region in a cross-sectional view that may be inspected may be about 100 nm² or less, but as the light source LTA is disposed to emit light tilted at a predetermined angle with respect to the surface of the comparison target 600, the region in a cross-sectional view that may be inspected may be set to about 25 μm² to about 30 μm² . Accordingly, a plurality of reliable reference images STM and a plurality of reliable reference data STD may be generated through the plurality of comparison images COM and the comparison data COD generated from the tilted light sources LTA.

The plurality of reference images STM and the plurality of reference data STD may be generated from the plurality of comparison data COD and the plurality of comparison images COM through a convolutional neural network. Specifically, a process (or artificial intelligence learning) of extracting common patterns from the plurality of comparison images COM and matching the comparison data COD for predicting oxygen vacancy distribution corresponding thereto may be performed. Thereafter, a step of generating data for predicting a specific oxygen vacancy distribution according to a specific image through learning may be performed. The plurality of reference images STM according to an embodiment of the inventive concept are the specific images, and the plurality of reference data STD correspond to data for predicting a specific oxygen vacancy distribution.

Referring to FIG. 1, an inspection image ISM obtained from an inspection target 500 including an oxide semiconductor may be output to the neutral network processing unit (S200). The inspection image ISM may be generated using energy dispersive spectroscopy (EDS). The inspection image ISM is a SEM image and may provide a cross-sectional view of the inspection target 500 as an image.

Referring to FIG. 2A, a region corresponding to the inspection image ISM may be a BB′ region. The BB′ region may be a partial region of the oxide semiconductor transistor STR. For example, the BB′ region may be a portion of the oxide semiconductor pattern A2.

Referring back to FIG. 1, the inspection image ISM is output, and then a selection reference image STM_S may be selected (S300). Thereafter, an oxygen vacancy distribution image OVM may be output from selection reference data STD_S corresponding to the selected selection reference image STM_S (S400). The oxygen vacancy distribution image OVM has information about the oxygen vacancy distribution for a partial region (specifically, the BB′ region) of the inspection target 500. Accordingly, information on the oxygen vacancy distribution for a fine region of an oxide semiconductor may be easily obtained.

After the outputting of the oxygen vacancy distribution image OVM (S400), a step of detecting whether the inspection target 500 is defective based on the oxygen vacancy distribution image OVM may be performed (S500). The oxygen vacancy distribution image OVM is an oxygen vacancy distribution map for a cross section of the inspection target 500, and may detect whether the oxygen vacancy distribution of the inspection target 500 is defective by comparing the oxygen vacancy distribution image OVM received from the neural network processing unit 300 with a predetermined distribution set value. When the inside of the inspection target 500 including an oxide semiconductor has an irregular distribution of oxygen vacancy, the oxide semiconductor may exhibit deteriorated electrical property due to reduced charge mobility. Therefore, whether the inspection target 500 is defective may be detected based on the oxygen vacancy distribution for the cross section of the inspection target 500 and a concentration of oxygen vacancy included in the oxide semiconductor by using the provided oxygen vacancy distribution image OVM.

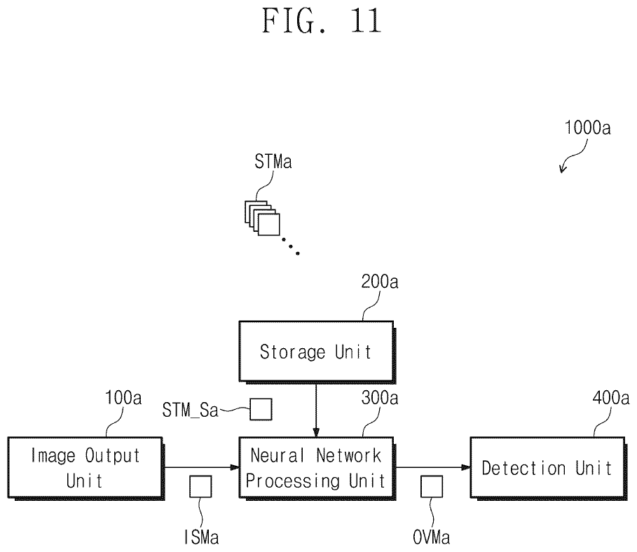

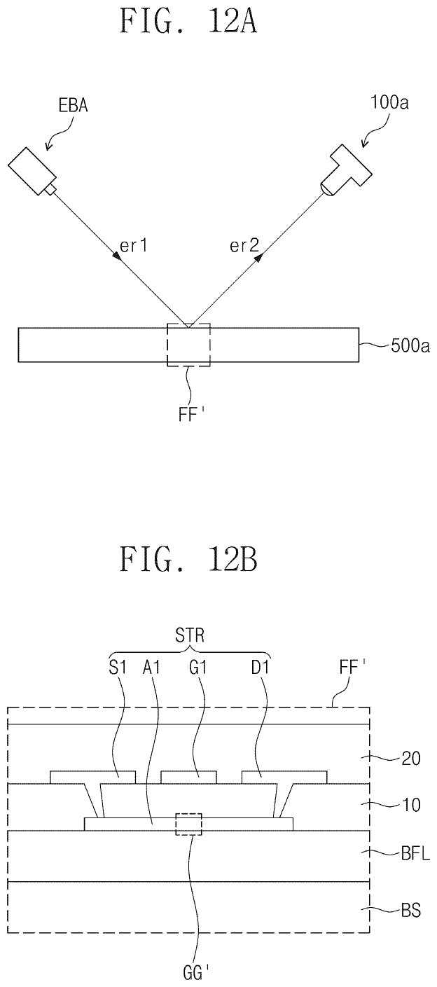

FIG. 11 is a block diagram of an inspection device according to an embodiment of the inventive concept. FIG. 12A is a cross-sectional view of a portion of an inspection device according to an embodiment of the inventive concept. FIG. 12B is a view enlarging region FF′ shown in FIG. 2A. Hereinafter, content overlapping the above descriptions will not be given.

Referring to FIG. 11, an inspection device 1000a may include an image output unit 100a, a storage unit 200a, a neural network processing unit 300a, and a detection unit 400a. The inspection device 1000a may correspond to one of the various types of inspection equipment for inspecting a structure of an organic material of an inspection target 500 (see FIG. 12A).

Referring to FIGS. 11 and 12A, the image output unit 100a may capture an inspection image ISMa obtained from an inspection target 500a. According to an embodiment of the inventive concept, the image output unit 100a may include an image capture apparatus such as an energy dispersive spectroscopy (EDS). However, the embodiment of the inventive concept is not limited thereto, and the image output unit 100a may include a scanning electron microscope or a transmission electron microscope as a method of spectroscopy. A beam output unit EBA in the image output unit 100a may provide an electron beam er1 to the inspection target 500a. The electron beam er1 may be directly incident on the inspection target 500a, and emission rays er2, for example, X-rays, may be emitted from the inspection target 500a.

The electron beam er1 may be directly incident on the inspection target 500a, and may thus emit core electrons included in the inspection target 500a. X-rays may be emitted as valence electrons are transferred to a space where the emitted core electrons are placed. That is, the emission rays er2 may be X-rays emitted when peripheral electrons are transferred to a space where the emitted core electrons are placed. The image output unit 100a may output the inspection image ISMa corresponding to the inspection target 500s from the emission rays er2. Specifically, the image output unit 100a may scan the emission rays er2 to detect elements inside the inspection target 500a, and provide a cross-sectional view of the inspection target 500a as an SEM image through mapping analysis. The output inspection image ISM may be provided to the neural network processing unit 300a.

The storage unit 200a may store a plurality of reference images STMa. The storage unit 200a may be a non-volatile memory device. The plurality of reference images STMa may be acquired based on the bonding type of an inspection organic material included in the inspection target 500a. Specifically, according to the bonding structure of an inspection organic material included in the inspection target 500a, different reference images STMa may be stored in the storage unit 200a. The plurality of reference images STM may be generated through an artificial neural network. Details will be described later.

The neural network processing unit 300a may output an organic material distribution image OVMa for the inspection target 500a. The neural network processing unit 300a may select one selection reference image ISM_Sa matched with or mostly similar to the inspection image ISMa by comparing the inspection image ISMa provided from the image output unit 100a with the plurality of reference images STMa stored in the storage unit 200a. Thereafter, the neural network processing unit 300a may output the organic material distribution image OVMa corresponding to the selection reference image STM_Sa. The organic material distribution image OVMa corresponds to an image for a distribution map of a plurality of inspection organic materials for a cross-section of the inspection target 500a.

The detection unit 400a may receive the organic material distribution image OVMa from the neural network processing unit 300a. The detection unit 400a may detect the type of inspection organic materials, which are different in bonding structure, included in the inspection target 500a based on the organic material distribution image OVMa, using a predetermined distribution setting value. Specifically, a specific organic material included in the inspection target 500a including an oxide semiconductor is formed in a channel region of the oxide semiconductor, and, accordingly, charge mobility may be reduced, resulting in low electrical characteristics. Accordingly, the detection unit 400a may determine whether a specific organic material is disposed around the channel region of the inspection target 500a based on the provided organic material distribution image OVMa to detect defects of the inspection target 500a.

Referring to FIG. 12B, the inspection target 500 may include a base layer BS and an oxide semiconductor transistor STR. The inspection target 500a shown in FIG. 12B may be substantially the same as the inspection target 500 shown in FIG. 2B. The inspection target 500a may include a plurality of inspection organic materials. For example, a plurality of inspection organic materials may be disposed around an oxide semiconductor pattern A1 included in the inspection target 500a.

Referring to FIGS. 11 to 12B together, a region corresponding to the inspection image ISMa may be a GG′ region. The GG′ region may be a partial region of the oxide semiconductor transistor STR. For example, the GG′ region may be a portion of the oxide semiconductor pattern A1. The electron beam er1 may be provided to the GG′ region of the inspection target 500a, and the emission rays er2 emitted from the GG′ region may be provided to the image output unit 100a. The image output unit 100a may scan the emission rays er2 to provide the inspection image ISMa corresponding to the GG′ region of the inspection target 500a. That is, the inspection image ISMa may be a cross-sectional view corresponding to a partial region of the oxide semiconductor transistor STR, specifically, a portion of the oxide semiconductor pattern A1. An area of the GG′ region in a cross-sectional view may be about 900 nm² to about 8100 nm². Specifically, an area of the GG′ region in a cross-sectional view may be about 900 nm² to about 1600 nm². In the present description, the GG′ region is shown as a cross-sectional view corresponding to a portion of the oxide semiconductor pattern A1 according to an embodiment of the inventive concept, but is not limited thereto as long as it is a region in which organic materials are disposed.

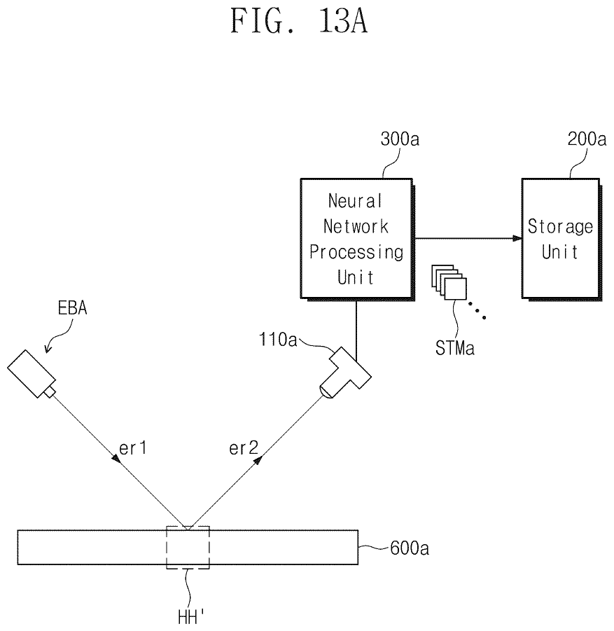

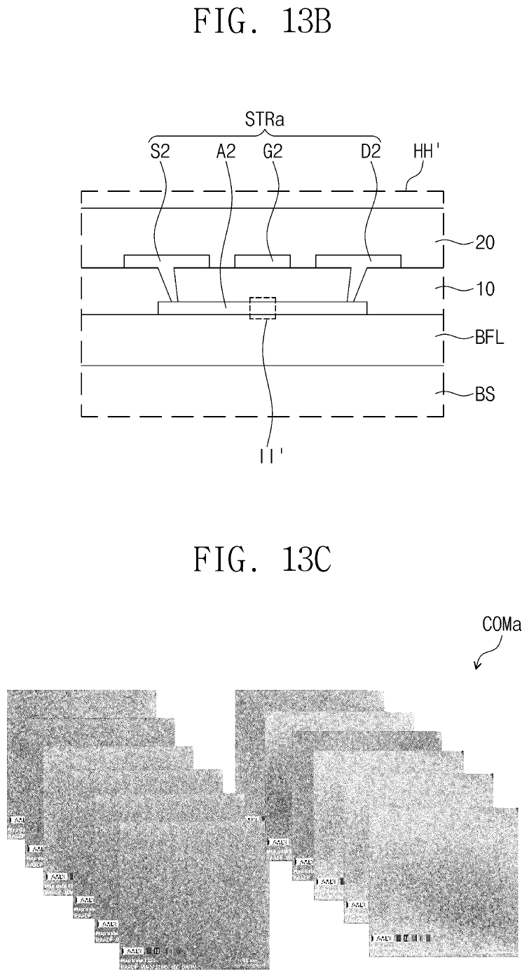

FIG. 13A is a view showing a process of storing reference images and reference data of an inspection device according to an embodiment of the inventive concept. FIG. 13B is a view enlarging region HH′ shown in FIG. 13A. FIG. 13C is a view showing a comparison image according to an embodiment of the inventive concept. Hereinafter, a process of generating the reference image STMa and the reference data STDa will be described in detail with reference to FIGS. 13A to 13C.

Referring to FIGS. 13A to 13C, a comparison image output unit 110a may output a comparison image COMa obtained from a comparison target 600a. According to an embodiment of the inventive concept, the comparison image COMa may be an image showing a cross-section of the comparison target 600a. Specifically, the comparison image COMa may be an image showing a cross-section of the comparison target 600a as a distribution map of a plurality of organic materials. According to an embodiment of the inventive concept, the comparison image COMa may be generated using an energy dispersive spectroscopy (EDS). However, the embodiment of the inventive concept is not limited thereto, and the comparison image COMa may be generated using a scanning electron microscope or a transmission electron microscope as a method of spectroscopy. That is, the comparison image COMa may be generated in the same manner as the inspection image ISMa described with reference to FIG. 12A. A plurality of comparison images COMa may be provided. A plurality of comparison targets 600a may be provided, and correspondingly, a plurality of comparison images COMa for the comparison target 600a may be provided. The generated plurality of comparison images COMa may be provided to the neural network processing unit 300a.

The comparison target 600a may have the same structure as the inspection target 500a (see FIG. 12A). The comparison target 600a may include a base layer BS and an oxide semiconductor transistor STRa. The oxide semiconductor transistor may include an oxide semiconductor pattern A2. The oxide semiconductor transistor STRa may include a metal oxide semiconductor.

A region corresponding to the comparison image COMa may be an II′ region. The II′ region may include a partial region of the oxide semiconductor transistor STRa. For example, the II′ region may include a portion of an oxide semiconductor pattern A2. The comparison image COMa corresponds to a portion of the oxide semiconductor pattern A2 and may thus correspond to data for generating the reference image STMa (see FIG. 13A). An area of the II′ region in a cross-sectional view may be about 900 nm² to about 8100 nm². Specifically, an area of the II′ region in a cross-sectional view may be about 900 nm² to about 1600 nm².

The neural network processing unit 300a may generate a plurality of reference images STMa, using a plurality of comparison images COMa. The plurality of reference images STMa may be generated using an algorithm. The algorithm may include artificial intelligence (AI) that mimics the way humans think. The artificial intelligence may include algorithms such as machine learning and deep learning. For example, the algorithm may use a convolutional neural network (CNN) as one of the deep learning algorithms.

The characteristics of a plurality of organic materials, which are different in structure may be extracted through the plurality of comparison images COMa provided to the neural network processing unit 300a. A process (or artificial intelligence learning) of extracting common patterns from the plurality of comparison images COM and matching an image corresponding to an organic material including a specific bond corresponding thereto may be performed. Through the learning, the neural network processing unit 300a may generate a specific image for an organic material including a specific structure. The plurality of reference images STMa according to an embodiment of the inventive concept correspond to the specific images. The plurality of reference images STMa generated through the learning algorithm may be stored in the storage unit 200a, and then used to predict the distribution of a specific organic material in the inspection target 500a (see FIG. 12A).

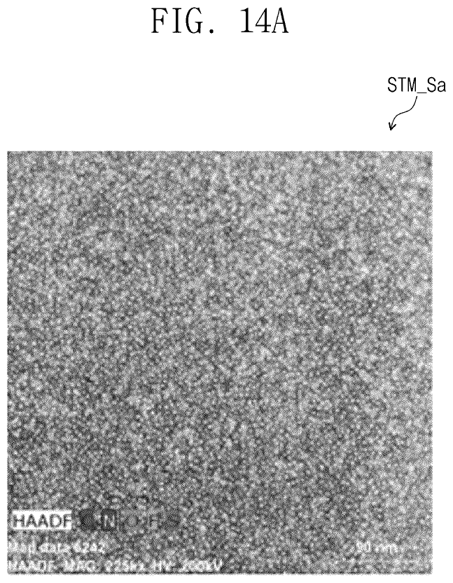

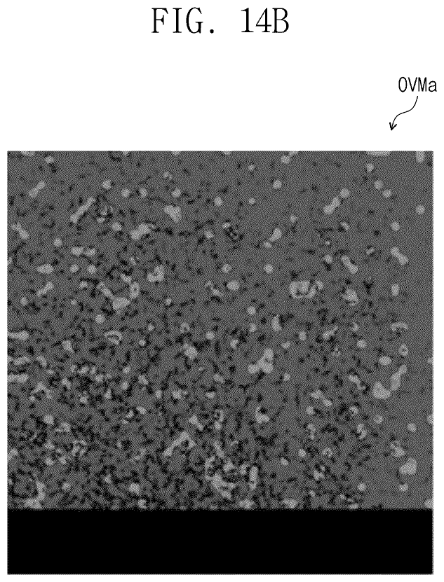

FIG. 14A is a view showing a selection reference image according to an embodiment of the inventive concept, and FIG. 14B is a view showing an organic material distribution image according to an embodiment of the inventive concept.

Referring to FIGS. 14A and 14B, an organic material distribution image OVMa may be formed based on a selection reference image STM_Sa. The selection reference image STM_Sa corresponds to an image selected corresponding to the inspection image ISMa (see FIG. 11) among the plurality of reference images STMa (see FIG. 13A). The organic material distribution image OVMa shows the distribution of a plurality of inspection organic materials in a portion corresponding to a portion of the inspection target 500a (see FIG. 12A). Specifically, the organic material distribution image OVMa is an image showing the distribution of inspection organic materials in a portion corresponding to the GG′ region of the oxide semiconductor transistor STR shown in FIG. 12B. The neural network processing unit 300a (see FIG. 13A) may generate the organic material distribution image OVMa based on the selection reference image STM_Sa. The selection reference image STM_Sa is a cross-sectional view of a portion corresponding to the GG′ region of the oxide semiconductor transistor STR, and inspection organic materials shown in the selection reference image STM_Sa may be marked in red on the organic material distribution image OVMa through a learned algorithm. For example, portions marked in red may correspond to specific organic materials subjected to inspection, and the other portions may be organic materials or include other non-organic materials. The distribution of inspection organic materials specified for a specific portion of the inspection target 500a may be easily determined through the organic material distribution image OVMa.

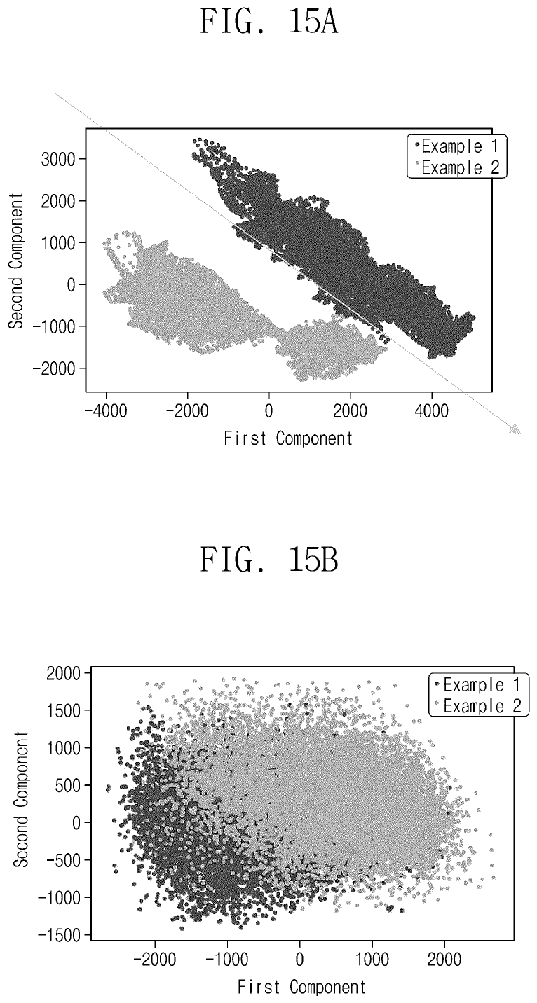

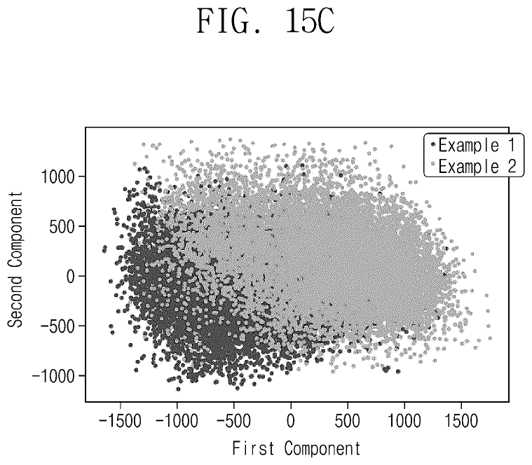

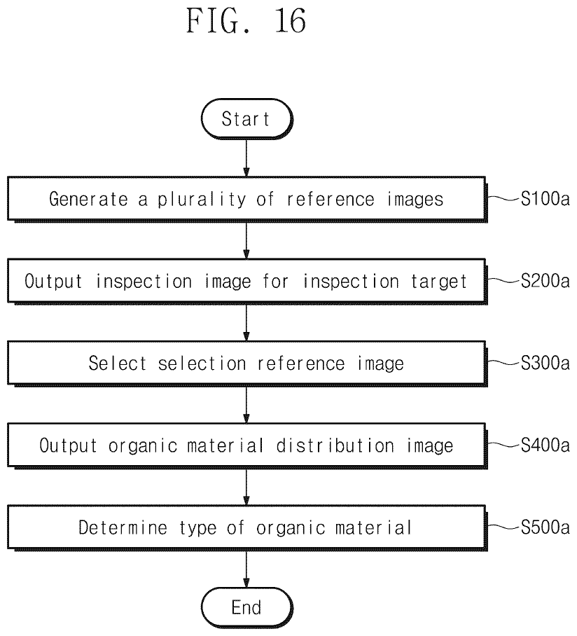

FIGS. 15A to 15C are graphs showing a distribution map of inspection organic materials included in an inspection target, using an inspection device according to an embodiment of the inventive concept. Specifically, FIGS. 15A to 15C are graphs showing whether different types of inspection organic materials are distinguishable according to an area of the GG′ region shown in FIG. 12B. FIGS. 15A to 15C are graphs in which high-dimensional data are reduced to low-dimensional data using principal component analysis (PCA). In the principal component analysis, orthogonal transformation may be used to convert samples of a high-dimensional space, which are likely to be correlated, into samples of a low-dimensional space, which are linearly uncorrelated. In PCA, linear transformation is performed on data to a new coordinate system such that, when data is mapped to one axis, an axis on which a variance thereof is largest is set as a first component, and an axis on which a variance thereof is next largest is set as a second component. That is, the first component shown in FIGS. 15A to 15C corresponds to the x-axis, and the second component corresponds to the y-axis. In an embodiment of the inventive concept, Example 1 and Example 2 each refer to inspection organic materials, which are different in structure. For example, Example 1 corresponds to cellulose, and Example 2 corresponds to protein.

FIG. 15A is a graph showing a case in which an area of the GG′ region shown in FIG. 12B is about 900 nm² to about 1600 nm². Referring to FIG. 15A, it is seen that Example 1 and Example 2 are distinguished from each other by a diagonal line crossing the graph. That is, when the principal component analysis is performed, Example 1 and Example 2, which are different in bonding structure, may well be distinguished from each other as different materials.

FIG. 15B is a graph showing a case in which an area of the GG′ region shown in FIG. 12B is about 100 nm² to about 400 nm². FIG. 15B is a graph showing a case in which an area of the GG′ region shown in FIG. 12B is about 25 nm to about 90 nm². Referring to FIGS. 15B and 15C, based on the principal component analysis performed on Example 1 and Example 2, it is seen that Example 1 and Example 2 are shown mixed together. In FIGS. 15B and 15C, when a fine region is subjected to inspection, it is seen that Example 1 and Example 2 are shown in an overlapping region, making it difficult to distinguish Example 1 and Example 2 each other.

That is, referring to FIGS. 15A to 15C, it is determined that when the inspection target 500a (see FIG. 12A) is inspected through the inspection device 1000a (see FIG. 11) according to an embodiment of the inventive concept, the size of a region that may be inspected (e.g., the GG′ region) is required to be set to about 900 nm² to about 1600 nm², and when the size of an inspection region is about 400 nm² or less, inspection organic materials, which are different in structure, included in the inspection target 500a are hardly distinguishable.

FIG. 16 is a flowchart of a method of inspection according to an embodiment of the inventive concept. Hereinafter, a method of inspection according to an embodiment of the inventive concept will be described with reference to FIGS. 11 to 16.

The neural network processing unit 300a may generate a plurality of reference images STMa. The plurality of reference images STMa may be generated through learning a plurality of comparison images COMa obtained from the comparison target 600a.

The plurality of comparison images COMa may be generated using an energy dispersive spectroscopy (EDS) for the II′ region of the comparison target 600a. The II′ region may include a partial region of the oxide semiconductor transistor STRa, specifically, a portion of the oxide semiconductor pattern A2. An area of the II′ region in a cross-sectional view is about 900 nm² to about 1600 nm², and the comparison image COMa may be provided as a cross-sectional image corresponding to a portion of the oxide semiconductor pattern A2.

The plurality of reference images STMa may be generated through a convolutional neural network based on the plurality of comparison images COMa. Specifically, a process (or artificial intelligence learning) of extracting common patterns from the plurality of comparison images COMa and matching an image corresponding to an organic material including a specific bond corresponding thereto may be performed. Thereafter, generating a specific image for an organic material including a specific structure may be performed through learning. The plurality of reference images STMa according to an embodiment of the inventive concept correspond to the specific images.

The inspection image ISMa obtained from the inspection target 500a including an oxide semiconductor and a plurality of organic materials may be output (S200a). The inspection image ISMa may be generated using an energy dispersive spectroscopy (EDS). The inspection image ISMa is an SEM image and may provide a cross-sectional view of the inspection target 500a as an image.

A region corresponding to the inspection image ISMa may be a GG′ region. The GG′ region may be a partial region of the oxide semiconductor transistor STR. For example, the GG′ region may be a portion of the oxide semiconductor pattern A2.

The inspection image ISMa is output, and then a selection reference image STM_Sa may be selected (S300a). Thereafter, an organic material distribution image OVMa may be output based on the selected selection reference image STM_Sa (S400a). The organic material distribution image OVMa is an image showing the distribution of organic materials in a partial region (specifically, the GG′ region) of the inspection target 500a. Through the organic material distribution image OVMa, the type of organic materials in a fine region of an oxide semiconductor may be easily determined.

After the generating of the organic material distribution image OVMa (S400a), determining the type of organic materials included in the inspection target 500a based on the organic material distribution image OVMa may be performed (S500a). The organic material distribution image OVMa is a distribution map of organic materials on a cross-section of the inspection target 500a, and may detect the type of organic materials included in the inspection target 500a. A specific organic material included in the inspection target 500a is formed in a channel region of an oxide semiconductor, and, accordingly, charge mobility may be reduced, resulting in low electrical characteristics. Accordingly, defects of the inspection target 500a may be detected by determining whether a specific organic material is disposed around the channel region of the inspection target 500a based on the organic material distribution image OVMa.

An inspection device according to an embodiment of the inventive concept may obtain an oxygen vacancy distribution image of a fine semiconductor region of an inspection target including an oxide semiconductor through a plurality of reference images and a plurality of reference data obtained through an algorithm. Accordingly, the inspection device may perform a reliable inspection on the inspection target.

In addition, an inspection device according to an embodiment of the inventive concept may obtain a distribution image for organic materials disposed around a semiconductor region of an inspection target including a plurality of inspection organic materials through a plurality of reference images obtained through an algorithm. The inspection device may detect the type of fine-sized organic materials, which are different in bonding structure through a distribution image for organic materials. Accordingly, a reliable inspection on the inspection target may be performed.

Although the present disclosure has been described with reference to a preferred embodiment of the inventive concept, it will be understood that the inventive concept should not be limited to these preferred embodiments but various changes and modifications may be made by those skilled in the art without departing from the spirit and scope of the present disclosure.

Hence, the technical scope of the present disclosure is not limited to the detailed descriptions in the specification but should be determined only with reference to the claims.

What is claimed is:

1. An inspection device comprising:
an image output unit configured to output an inspection image for an inspection target including an oxide semiconductor;
a storage unit configured to store a plurality of reference images and a plurality of reference data indicating oxygen vacancy distribution which are generated through an artificial neural network; and
a neural network processing unit configured to compare the inspection image with the reference images and select a selection reference image corresponding to the inspection image, and output an oxygen vacancy distribution image based on selection reference data corresponding to the selection reference image.

2. The inspection device of claim 1, wherein the reference images and the reference data are generated by learning comparison images for a plurality of comparison targets comprising an oxide semiconductor, and comparison data indicating oxygen vacancy distributions of the comparison targets through the artificial neural network.

3. The inspection device of claim 2, wherein the comparison image is generated from a first region of the comparison target and the comparison data is generated from a second region of the comparison target.

4. The inspection device of claim 3, wherein the second region is larger than the first region.

5. The inspection device of claim 4, wherein the first region is a portion of the second region.

6. The inspection device of claim 3, wherein the first region corresponds to a portion of the oxide semiconductor.

7. The inspection device of claim 3, wherein an area of the first region is about 900 nm² to about 1600 nm².

8. The inspection device of claim 2, wherein the comparison target includes a plurality of comparison targets and oxide semiconductors included in the plurality of comparison targets are different in concentration of oxygen vacancy.

9. The inspection device of claim 2, wherein the comparison data is generated using X-ray photoelectron spectroscopy (XPS).

10. The inspection device of claim 2, wherein each of the inspection image and the comparison image are generated using an energy dispersive spectroscopy (EDS).

11. The inspection device of claim 1, wherein the artificial neural network is a convolutional neural network.

12. The inspection device of claim 1, wherein the plurality of reference images are acquired using samples each having a predetermined oxygen vacancy concentration.

13. The inspection device of claim 1, further comprising a detection unit configured to detect whether the inspection target is defective based on the oxygen vacancy distribution image.

14. A method of inspection, the method comprising:
generating a plurality of reference images and a plurality of reference data indicating oxygen vacancy distribution through an artificial neural network;
outputting an inspection image for an inspection target including an oxide semiconductor;
selecting a selection reference image corresponding to the inspection image by comparing the inspection image with the reference images; and
outputting an oxygen vacancy distribution image based on selection reference data corresponding to the selection reference image.

15. The method of claim 14, wherein the generating of the reference images and the reference data comprises learning comparison image for comparison target including oxide semiconductors, and comparison data indicating an oxygen vacancy distributions of the comparison target through the artificial neural network.

16. The method of claim 15, wherein the comparison image is generated from a first region of the comparison target and the comparison data is generated from a second region of the comparison target.

17. The method of claim 16, wherein the comparison data is generated using X-ray photoelectron spectroscopy (XPS).

18. The method of claim 17, wherein the comparison data is generated by a light source disposed to emit light having a predetermined angle with respect to a surface of the comparison target.

19. The method of claim 16, wherein the comparison image is generated using energy dispersive spectroscopy (EDS).

20. The method of claim 14, further comprising detecting whether the inspection target is defective based on the oxygen vacancy distribution image.

21. An inspection device comprising:
an image output unit configured to output an inspection image for an inspection target including a plurality of inspection organic materials;
a storage unit configured to store a plurality of reference images generated through an artificial neural network and corresponding to each of the plurality of organic materials; and
a neural network processing unit configured to select a selection reference image corresponding to the inspection image by comparing the inspection image with the reference images, and output an organic material distribution image based on the selection reference image.

22. The inspection device of claim 21, wherein the reference images are generated by learning a comparison image for a comparison target including the plurality of organic materials through the artificial neural network.

23. The inspection device of claim 22, wherein the comparison target comprises a plurality of comparison targets, and
the plurality of organic materials included in the plurality of comparison targets are different in bonding structure.

24. The inspection device of claim 22, wherein each of the inspection image and the comparison image is generated using an energy dispersive spectroscopy (EDS).

25. The inspection device of claim 21, wherein the artificial neural network is a convolutional neural network.

26. The inspection device of claim 21, wherein the plurality of reference images are acquired based on the bonding type of the plurality of organic materials.

27. The inspection device of claim 21, further comprising a detection unit configured to determine the type of inspection organic materials included in the inspection target based on the organic material distribution image.

28. A method of inspection, the method comprising:
generating a plurality of reference images through an artificial neural network;
outputting an inspection image for an inspection target including a plurality of inspection organic materials;
selecting a selection reference image corresponding to the inspection image by comparing the inspection image with the reference images; and
outputting an organic material distribution image based on the selection reference image.

29. The method of claim 28, wherein the generating of the reference images comprises learning comparison images for a plurality of comparison targets including a plurality of organic materials through the artificial neural network.

30. The method of claim 29, wherein the comparison images are generated using an energy dispersive spectroscopy (EDS).

31. The method of claim 28, further comprising determining the type of inspection organic materials included in the inspection target based on the organic material distribution image.
